(19) United States
(12) Patent Application Publication
(10) Pub. No.: US 2014/0240241 A1
(43) Pub. Date: Aug. 28, 2014

(54) Monitor for Mobile Phone

(71) Applicant: Payam Moradian, Los Angeles, CA (US)

(72) Inventor: Payam Moradian, Los Angeles, CA (US)

(21) Appl. No.: 13/776,722

(22) Filed: Feb. 26, 2013

(51) Int. Cl. H04M 1/725; G06F 3/041

(52) U.S. Cl. CPC H04M 1/72527; G06F 3/041
USPC 345/173; 455/556.1

(57) ABSTRACT

Provided is a monitor comprising a touch screen and electronics for receiving and transmitting data from and to a mobile phone, wherein the monitor acts as if it is an actual monitor for the mobile phone by displaying what would have been displayed on the mobile phone's touch screen.

### BACKGROUND SECTION OF THE INVENTION

Two trends have dictated the use of computers in the past decades. One trend is the increase computing power of these computers. The second trend is the miniaturization of computers, to the point where an individual has a mobile phone that can act as a powerful computing device. These trends have resulted in an individual having multiple computing devices, such as mobile phone, tablet, laptop, and a personal computer. The use of multiple computing devices by an individual is inconvenient. For example, the individual no longer has a single place for all its files. There is a need in the art to minimize the number of computing devices that an individual needs to use while maintaining the functionality of the different personal computing devices.

### SUMMARY SECTION OF THE INVENTION

Provided is a monitor comprising a touch screen and electronics for receiving and transmitting data from and to a mobile phone, wherein the monitor acts as if it is an actual monitor for the mobile phone by displaying what would have been displayed on the mobile phone's touch screen. The monitor can have a front and a back, the front being the touch screen, and the back having a recess for placing the mobile phone. The monitor can have a front and a back, the front being the touch screen, and the back having a male mating part for connection to a mobile phone. After attachment of the mobile phone, a uniform surface can be obtained in the back of the monitor. The monitor can have a front and a back, the front being the touch screen, and the back having a slot for placing the mobile phone. The monitor can have a front and a back, the front being the touch screen, and the back having a rotating member for placing a mobile phone. The monitor's most powerful processing unit can be built as a microcontroller. The monitor can further comprise a camera, microphone, and a speaker to act as input/output devices for the mobile phone. The monitor's sole purpose can be to act as an input/output device for the mobile phone. The monitor can provide one or more of additional processing power, memory or storage for the mobile phone. The monitor can provide network connection (such as WiFi, LTE) for the mobile phone. The monitor can be that of a laptop computer or personal computer or tablet computer. The monitor can display both the mobile phone's screen and a screen outputted by the monitors' own electronics. The mobile phone can display applications differently depending on size of the monitor. The touch screen can have a screen size (diagonal) of about 6 inches to about 14 inches, such as about 8 inches to about 12 inches.

Provided is a mobile phone comprising a touch screen, battery, camera, network connection, central processing unit, microphone, speaker, memory, storage, wherein the mobile phone can be removably attached to a monitor, and depending on screen size of the monitor, the mobile phone displays a different user interface or displays applications differently. The decision as to which display to use can be automatic or manual.

### BRIEF DESCRIPTION OF THE FIGURES

FIG. 1 is an illustration of a mobile phone (top) docking with a computing device, such as a tablet computer (bottom), that has a large monitor.

FIG. 2 is an illustration of a mobile phone (top) docking with a monitor (bottom) whose only function is to act as an input/output device.

FIG. 3 is an illustration of the mobile phone's operating system using a different GUI depending on the size of the monitor.

FIG. 4 is an illustration of a GUI for a PC or laptop computer.

FIG. 5 is an illustration of a GUI for a mobile phone or a tablet computer.

FIG. 6 is an illustration of display of a website in a mobile phone or a tablet computer.

FIG. 7 is an illustration of display of a website in a PC or laptop computer.

FIG. 8 is an illustration of a front of a monitor having a touch sensitive screen.

FIG. 9 is an illustration of back of a monitor having a slot for placing a mobile phone.

FIG. 10 is an illustration of back of a monitor having a slot for placing a mobile phone.

FIG. 11 is an illustration of back of a monitor having a recess for placing a mobile phone.

FIG. 12 is an illustration of back of a monitor having a rotating member for placing a mobile phone.

FIG. 13 is an illustration of back of a monitor with a rotating member having a mobile phone placed therein in a closed position to provide a uniform surface.

FIG. 14 is an illustration of the front view of the rotating member.

FIG. 15 is an illustration of the back view of the rotating member.

FIG. 16 is an illustration of the side view of the rotating member.

FIG. 17 is an illustration of both the mobile phone and a computing device providing simultaneous content on the monitor of the computing device.

### DETAILED DESCRIPTION OF THE INVENTION

The present invention provides for monitors that can be used with mobile phones. The mobile phone can have an operating system and/or a graphic user interface that adjusts the experience of a user according to the size of the monitor attached to the mobile phone. For example, if a monitor the size of a tablet computer is used, the mobile phone can display icons for applications and adjust the view and experience of the applications so that a user would have the same experience as if the user was using a tablet computer. Also provided are monitors, particularly touch sensitive monitors the size of a tablet computer, for detachably attaching mobile phones. The monitor (18) that is connected to the mobile phone can have a docking port (3) that is typically a male mating part. The function of the monitor (18) is to provide input to the mobile phone through its touch screen monitor, provide output with a larger screen, and provide optional peripherals like cameras. The monitor (18) can have its own power source (8).

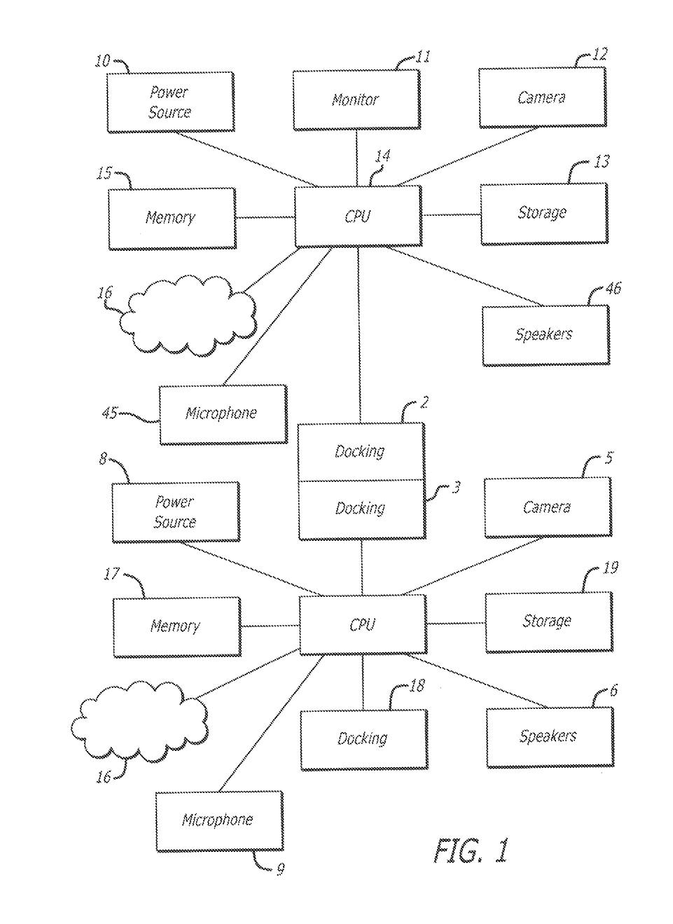

FIG. 1 illustrates a connection between a mobile phone (top) and a computing device with a monitor (bottom), such as tablet computer. The mobile phone can have the typical components of such phones, such as a CPU (14), monitor (11), power source (battery) (10), memory (such as RAM) (15), storage (such as flash drive) (13), network connection (16), a docking port (2), a speaker (46), and a microphone (45). The docking port (2) can be used to connect the mobile phone to a tablet computer, PC or laptop computer. In FIG. 1, the docking port (2) is used to connect the mobile phone to a touch sensitive monitor that is the size of a monitor of a tablet computer. The docking port of a mobile phone is typically a female mating part. The connection can also be without a docking port with a wireless connection. FIG. 1 shows a mobile phone that is connected to a monitor that is a fully functional tablet computer. The tablet computer can have a CPU (47), memory (such as RAM) (17), Storage (such as flash drive) (19), camera (5), power source (battery) (8), a network connection (16), and a touch sensitive monitor (18). The tablet computer can either act as a sole input/output device, or add the capability of the mobile phone by adding additional computing power, storage, and/or memory. Similar connection can be made with a laptop computer or PC.

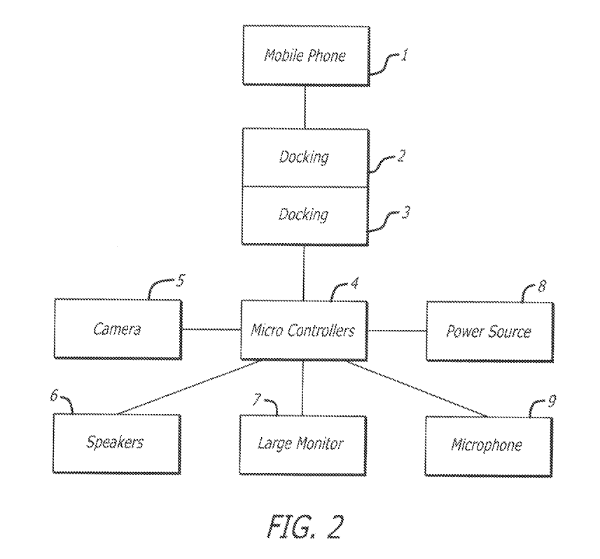

FIG. 2 illustrates a monitor (7) that can be cheaply manufactured with the use of a microcontroller (4). A microcontroller (sometimes abbreviated μC, uC or MCU) is a small computer on a single integrated circuit containing a processor core, memory, and programmable input/output peripherals. Program memory in the form of NOR flash or OTP ROM is also often included on chip, as well as a typically small amount of RAM. Microcontrollers are designed for embedded applications, in contrast to the microprocessors used in personal computers or other general purpose applications. The function of the monitor (7) with the microcontroller is limited in that of acting as a touch sensitive monitor. The monitor (7) does not add the computing power of the mobile phone, and solely acts as an input/output device.

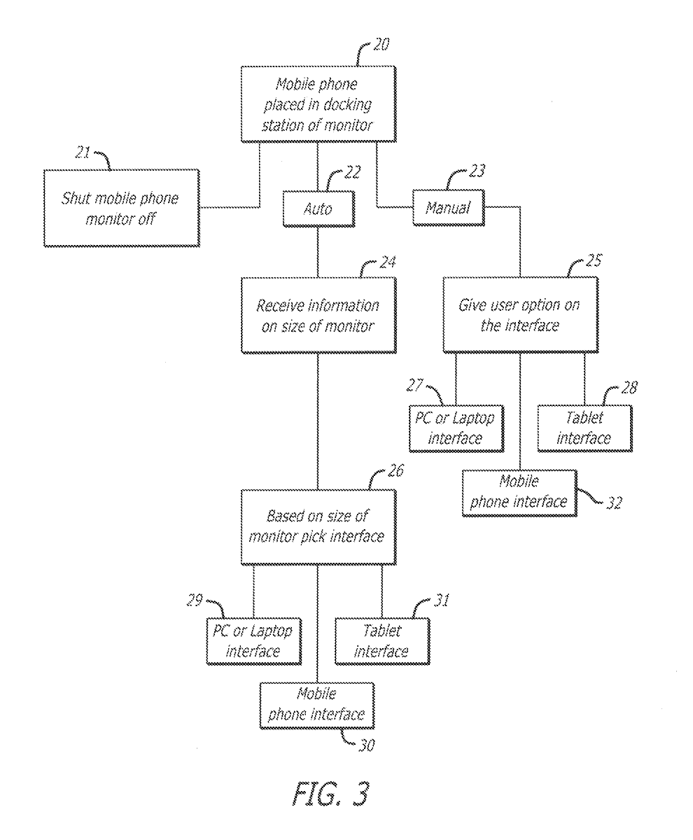

FIG. 3 shows a flow chart of a possible chain of events after a mobile phone is placed in the docking station of the monitor (20). The mobile phone would shut its own monitor down to conserve battery (21). In automatic mode (22), the mobile phone would receive information on the size of the monitor (24). Based on the size of the monitor, the operating system of the mobile phone can provide a PC (29), mobile phone (3), laptop (29), tablet computer (31), or mobile phone interface and experience. In manual mode (23), a user would select the desirable interface (25). A user can for example can select a PC or laptop interface (27), a tablet interface (28), or a mobile phone interface (32).

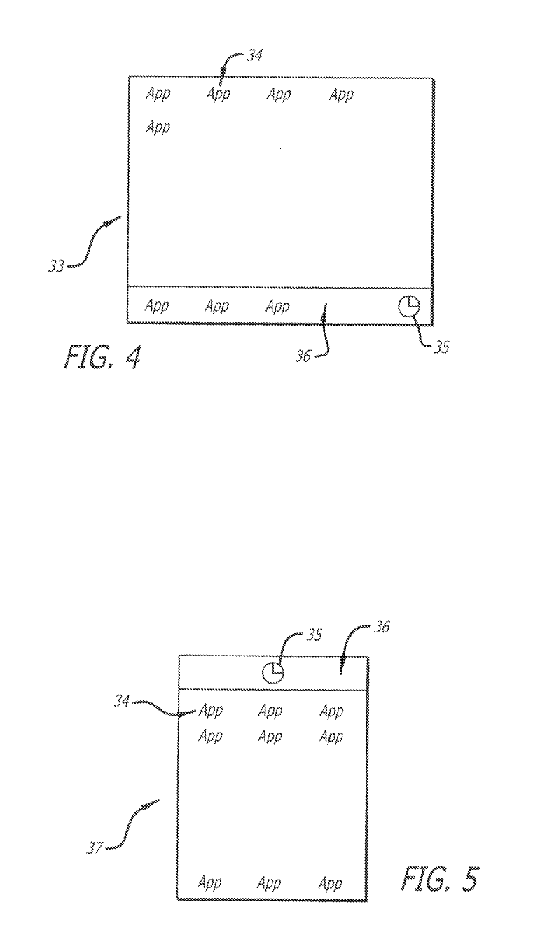

FIG. 4 shows a traditional PC or laptop graphic user interface (GUI). In this example, which is the Windows interface, Application icons (App) (34) are lined up starting from the top left. On the bottom, there is a bar (36) that has shortcuts for some of the applications. A clock (35) is shown on the bottom right side. FIG. 5 shows a GUI for a phone or tablet. The clock (35) is put on top in this GUI. The App's (34) are cramped into a smaller place. Depending on the size of the monitor, the operating system can choose a GUI according to FIG. 4 or 5, or some other GUI that is suitable for the size of the monitor.

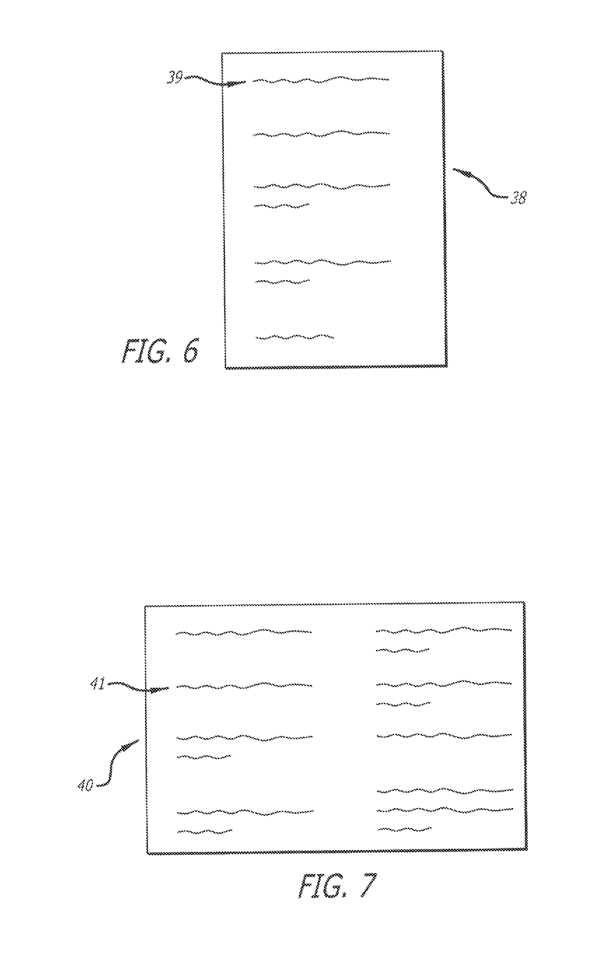

FIGS. 6 and 7 show how an application can have a different interface depending on a size of a monitor or the device. FIG. 6 shows display of a website (38) on a phone or a tablet computer. The content of the website (39) is adjusted to be in a single column because of the limited size of the monitor. FIG. 7 shows a display of the same website (40) on a laptop or personal computer. Because of the increase in the size of the monitor, the application interface displays the content (41) in multiple columns.

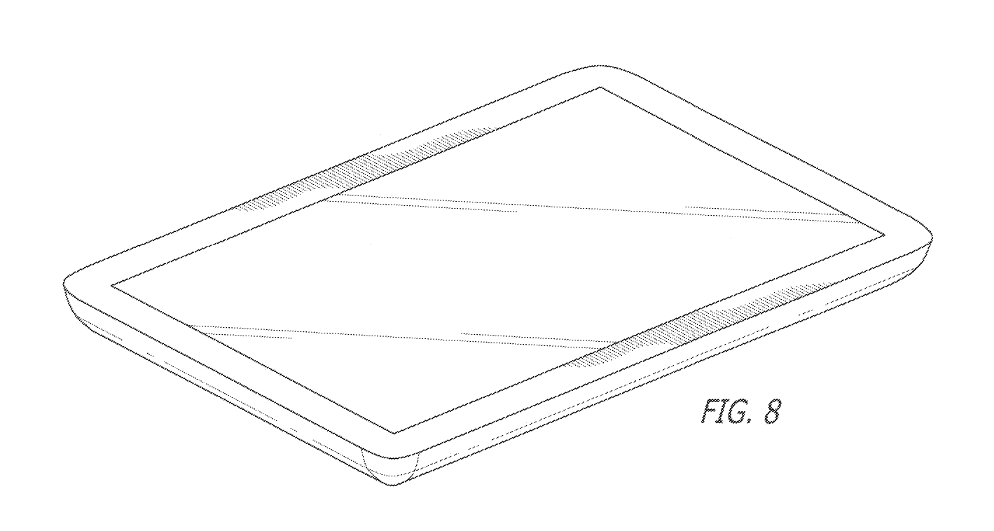

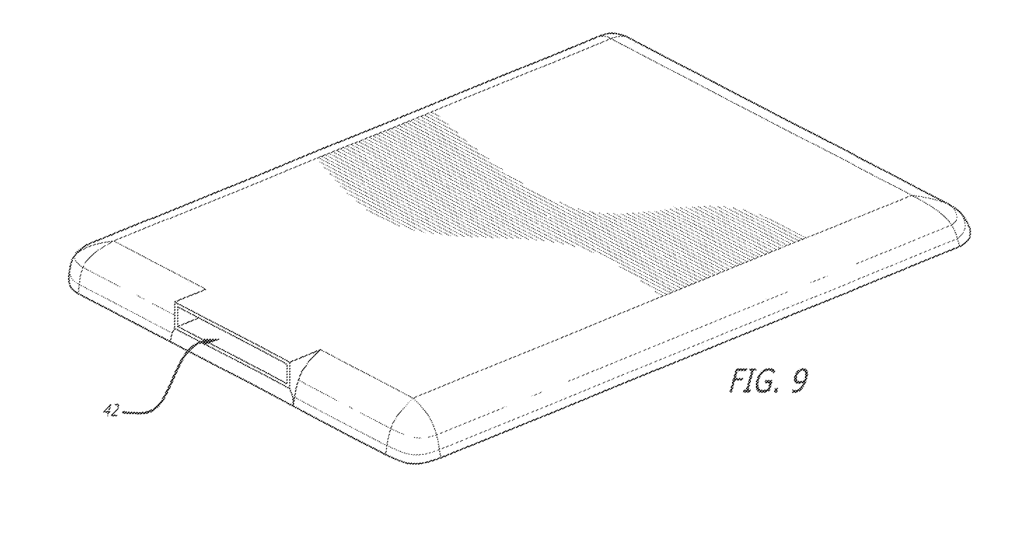

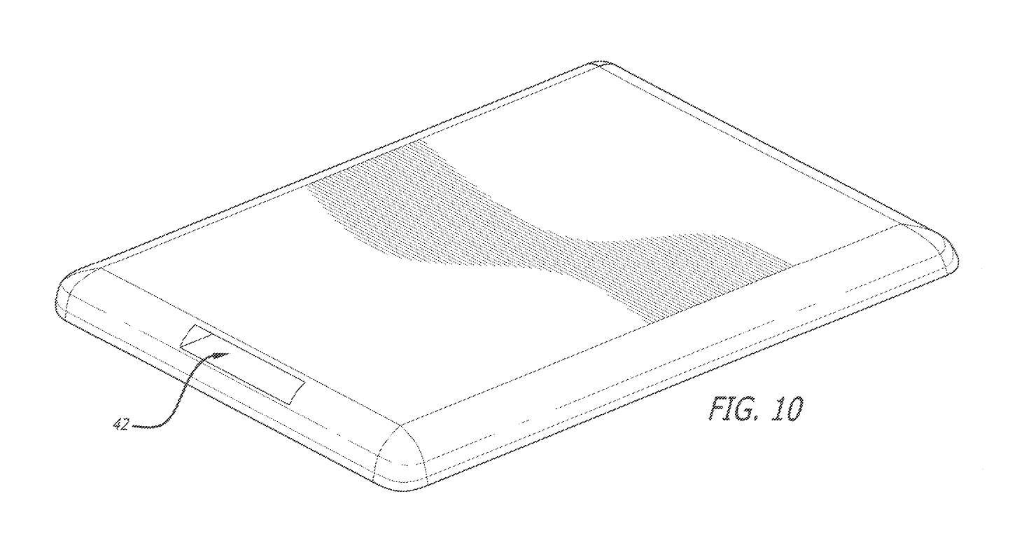

FIG. 8 shows a front perceptive of a monitor designed to receive a mobile phone in its back. The monitor can be either a full functioning tablet computer (FIG. 1) or a monitor whose main function is to act as an input/output device (FIG. 2) for the mobile phone. FIGS. 9 and 10 show the back of the monitor in one embodiment. The monitor has a slot (42) on the side for sliding in a mobile phone. The Slot covers the phone. The mobile phone can stick out of the slot or be entirely inside when in locked position. The mobile phone is removably locked in place such as with the use of a latch. The mobile phone can be released for example by pushing the mobile phone again or having a release button on the back of the monitor. The mobile phone can also be released by pulling the mobile phone if a portion of the mobile phone is out of the monitor. The monitor has a docking port (3) inside the slot for receiving the mobile phone.

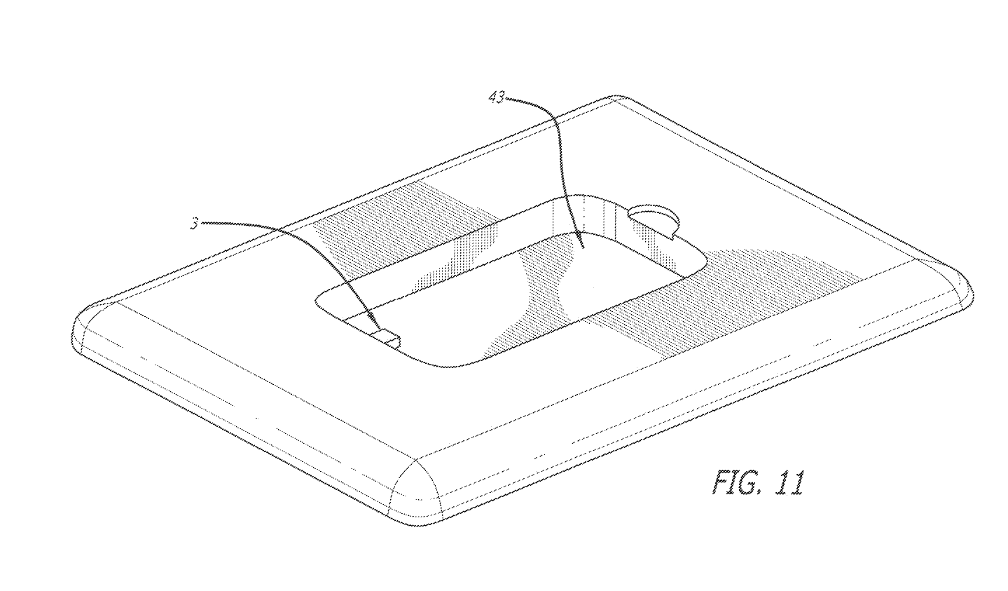

FIG. 11 shows another embodiment of the back of the monitor. In the embodiment, a recess (43) is placed in the back of the monitor. The recess is preferably in the middle of the device. A mobile phone is placed in the recess (43). The mobile phone connects to the docking port (3) of the monitor. Preferably, the mobile phone, when in place, makes a uniform flat surface with the monitor.

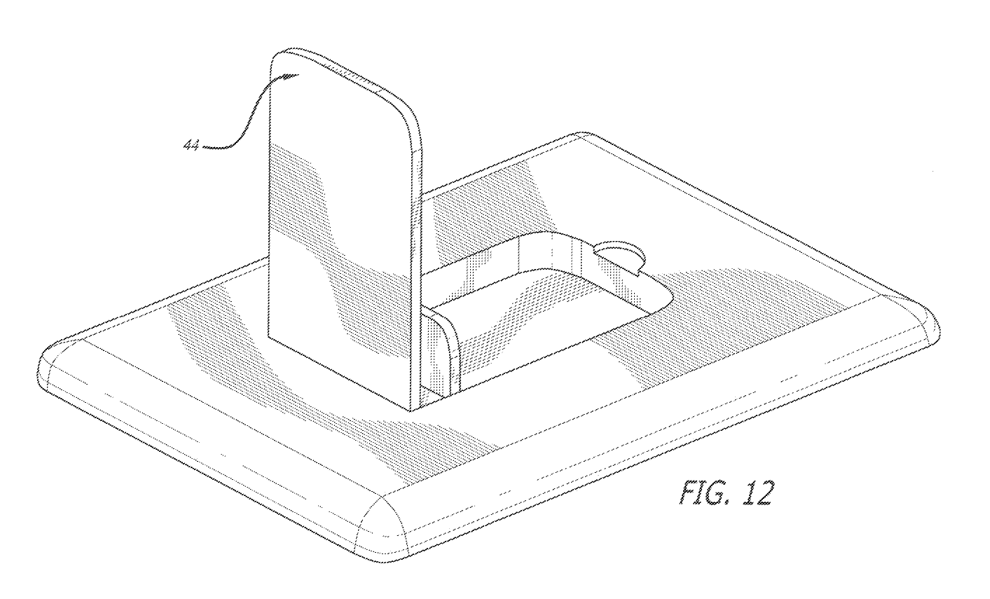

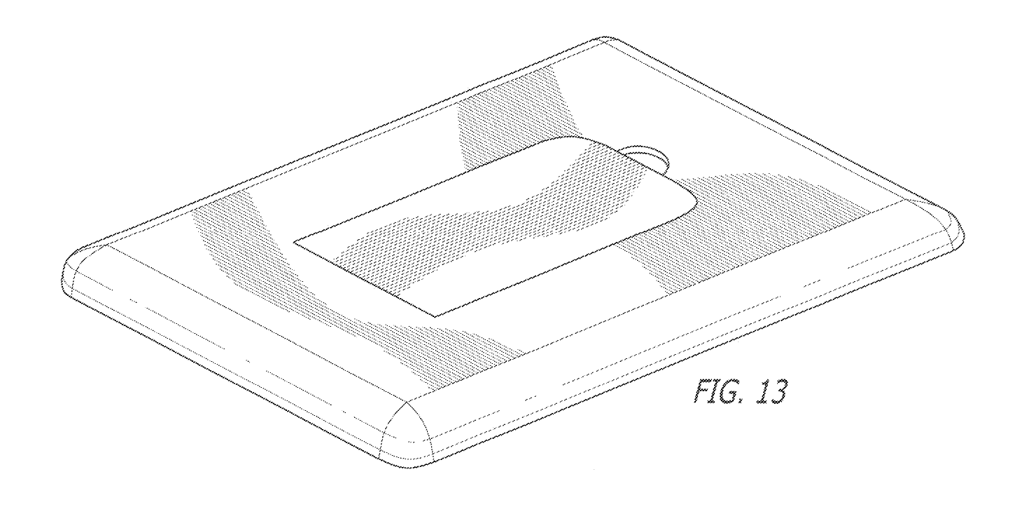

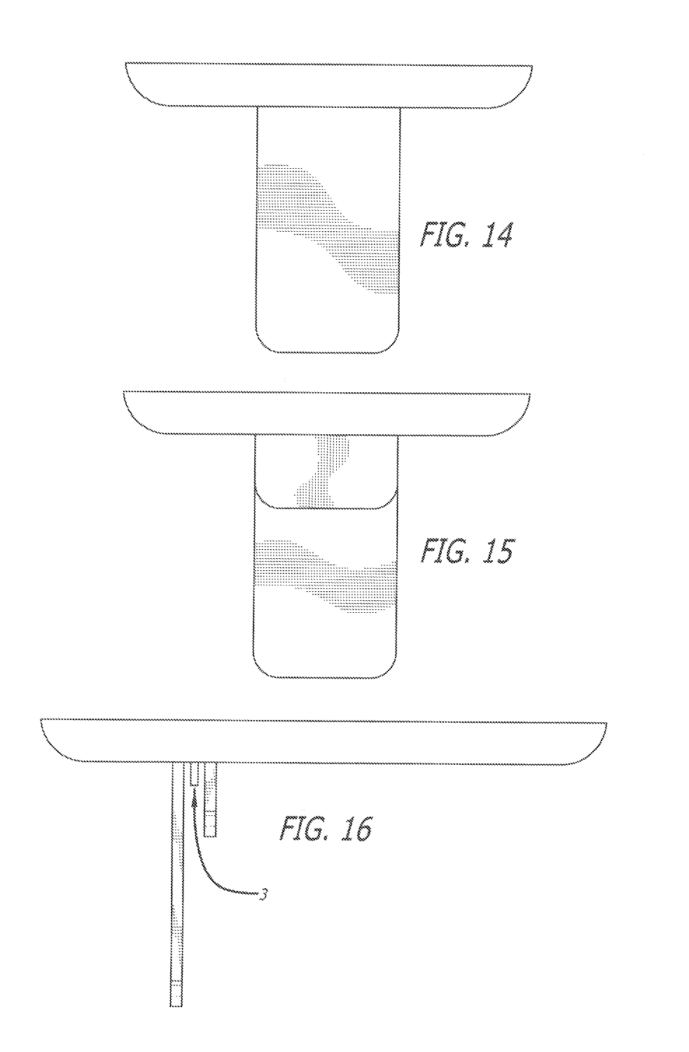

FIG. 12 shows another embodiment of the back of the monitor. The monitor has a rotating member (44) with a docking port (3) (shown in FIG. 16). The phone is placed in the rotating member, and the member is rotated so that preferably the back of the rotating member and the monitor make a uniform surface as shown in FIG. 13. The member can be locked into place with a latch. The member (44) can be unlocked for example by pushing in the member (44) or providing a button for unlocking the member. FIGS. 14-16 show different views of the member (44).

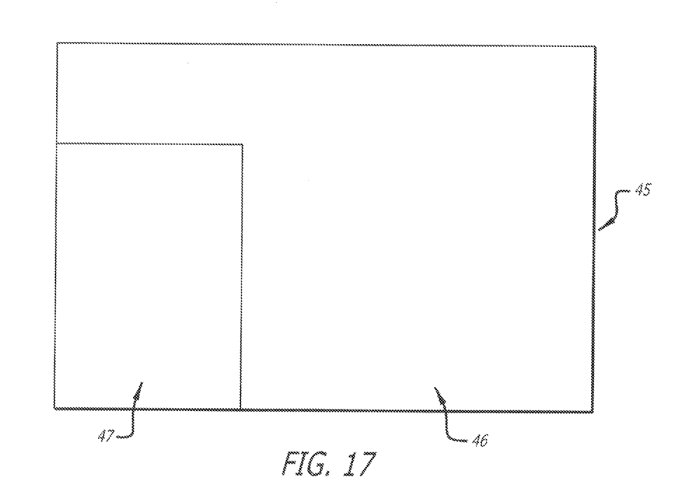

FIG. 17 is an embodiment where a computing device (45) displays both the mobile phone screen (47) and that that of the computing device itself (46). For example, a fully functioning tablet is attached to a mobile phone. A user sees on the screen the display (and content) provided from both the tablet computer's processor (46) and that of the cellular phone (47). The user can drag and move the mobile phone screen (47) anywhere within the screen and can expand or reduce it in size. A user can have the microphone, speaker and/or camera of the tablet computer (45) switch back and forth between the devices. For example, when a call is received, the microphone speaker and camera of the tablet computer (45) can act as input/output devices for the mobile phone's processor. When no active phone call exists, these input and output devices can work solely with the tablet computer's processor.

The monitor can be of any suitable size. In one embodiment, the monitor has a screen size of about 6 inches to about 14 inches.

What is claimed is:

1. A monitor comprising:
a. a touch screen;
b. electronics for receiving and transmitting data from and to a mobile phone having a touch screen;
wherein the monitor acts as if it is an actual monitor for the mobile phone by displaying what would have been displayed on the mobile phone's touch screen;
wherein the monitor displays both the mobile phone's screen and a screen outputted by the monitors' own electronics.

2. The monitor of claim 1, wherein the monitor has a front and a back, the front being the touch screen, and the back having a recess for placing the mobile phone.

3. The monitor of claim 1, wherein the monitor has a front and a back, the front being the touch screen, and the back having a male mating part for connection to a mobile phone.

4. The monitor of claim 3, wherein after attachment of the mobile phone, a uniform surface is obtained in the back of the monitor.

5. The monitor of claim 1, wherein the monitor has a front and a back, the front being the touch screen, and the back having a slot for placing the mobile phone.

6. The monitor of claim 1, wherein the monitor has a front and a back, the front being the touch screen, and the back having a rotating member for placing a mobile phone.

7. The monitor of claim 1, wherein the monitor's most powerful processing unit is built as a microcontroller.

8. The monitor of claim 1, wherein the monitor further comprises a camera, microphone, and a speaker to act as input/output devices for the mobile phone.

9. (canceled)

10. The monitor of claim 1, wherein the monitor provides one or more of additional processing power, memory or storage for the mobile phone.

11. The monitor of claim 1, wherein the monitor provides network connection for the mobile phone.

12. The monitor of claim 1, wherein the monitor is that of a laptop computer or personal computer.

13. The monitor of claim 1, wherein the monitor is that of a tablet computer.

14. (canceled)

15. (canceled)

16. The monitor of claim 1, wherein the mobile phone displays applications differently depending on size of the monitor.

17. The monitor of claim 1, wherein the touch screen has a diagonal screen size of about 6 inches to about 14 inches.

18. A mobile phone comprising:
a. a touch screen,
b. battery;
c. camera;
d. network connection;
e. central processing unit;
f. microphone;
g. speaker;
h. memory;
i. storage;
wherein the mobile phone can be removably attached to a monitor, and depending on screen size of the monitor, the mobile phone displays a different user interface or displays applications differently.

19. The mobile phone of claim 18, wherein the decision as to which display to use is automatic.

20. The mobile phone of claim 18, wherein the decision as to which display to use is manual.

21. The monitor of claim 1, wherein a user can drag and move the mobile phone screen within the screen of the monitor and can expand or reduce size of the mobile phone screen.

22. The monitor of claim 1, wherein when a call is received by the mobile phone, input devices of the monitor act as input/output device for the mobile phone's processor.
